(19) United States
(12) Patent Application Publication
(10) Pub. No.: US 2012/0215810 A1
(43) Pub. Date: Aug. 23, 2012

(54) DATABASE QUERY MECHANISM USING LINKS AS AN AGGREGATE BASE

(75) Inventors: Clark C. Evans, Ann Arbor, MI (US); Kyrylo Simonov, Ann Arbor, MI (US)

(73) Assignee: Prometheus Research, LLC, New Haven, CT (US)

(21) Appl. No.: 13/371,058

(22) Filed: Feb. 10, 2012

Related U.S. Application Data
(60) Provisional application No. 61/442,163, filed on Feb. 11, 2011.

(51) Int. Cl. G06F 17/30

(52) U.S. Cl. 707/771; 707/E17.014

(57) ABSTRACT

A method may include receiving a syntactic database query for retrieving information, where the syntactic database query may include two or more tokens. A subset of the two or more tokens may include a nested aggregation, and the nested aggregation may include at least (a) a first aggregate expression including a first aggregate function, a first base, and a first range, and (b) a second aggregate expression including a second aggregate function, a second base and a second range, where the second range includes the first aggregate expression. The method may further include parsing the two or more of tokens, where parsing includes identifying at least a first query context and a second query context.

### RELATED APPLICATIONS

The present application claims priority to U.S. Provisional Application No. 61/442,163 entitled “Database Query Mechanism Using Links as an Aggregate Base” and filed Feb. 11, 2011, the contents of which are hereby incorporated by reference in their entirety.

### BACKGROUND

Query syntax may include a number of individual tokens. A token, in some examples, may include a name referring to an entity (e.g., table, view, or other set of data with a similar structure) or a member of an entity (e.g., rows, values, portions of data belonging to an individual entity), or a name referring to a link between entities or to a particular entity. In other examples, a token may include a function or operator (e.g., average, count, list, group, etc.), or formatting syntax (e.g., parentheses, brackets, etc.). An aggregate expression may involve a calculation that maps a multiplicity of values from one data set (the “span” or the “range”) onto a single value in another data set (the “base”).

### SUMMARY

In one aspect, the present disclosure describes a method that may include receiving a syntactic database query for retrieving information, where the syntactic database query may include two or more tokens. A subset of the two or more tokens may include a nested aggregation, and the nested aggregation may include at least (a) a first aggregate expression including a first aggregate function, a first base, and a first range, and (b) a second aggregate expression including a second aggregate function, a second base and a second range, where the second range includes the first aggregate expression. The method may further include parsing the two or more tokens, where parsing includes identifying at least a first query context and a second query context. The first query context may include a first token of the two or more tokens including a first name. The second query context may include a second token of the two or more tokens including a second name. The method may further include accessing a system catalog including two or more entities and two or more named links, each named link of the two or more named links identifying an association between at least one entity of the two or more of entities. The method may further include binding the first query context to a first entity of the two or more entities in the system catalog based in part upon the first name, where the first query context includes the first aggregate expression. The method may further include determining a first association between the first entity and a second entity based in part upon both the second name and a first named link associated with the first entity in the system catalog. The method may further include binding the second query context to the second entity, where the second query context includes the second aggregate expression. The method may further include associating one or more rows of the first entity onto one or more sets of rows of the second entity. The method may further include generating first instructions, where the first instructions include conversion instructions for converting the one or more sets of rows of the second entity into a set of values using the second aggregate function. The method may further include generating second instructions, where the second instructions include aggregation instructions for performing the first aggregate function using the set of values.

The database may include a relational database. The system catalog may include a respective cardinality associated with each of the named links. The respective cardinality may include one of (a) a one-to-one correlation, (b) a one-to-many correlation, and (c) a many-to many correlation. The method may further include, prior to determining the association, verifying a first cardinality associated with the first named link is not a one-to-one cardinality.

The two or more of entities may include a scalar entity, and the first query context may be associated with the scalar entity. The first instructions and the second instructions may be generated as native programming interface instructions. The first instructions and the second instructions may be generated as query instructions. The syntactic database query, the first instructions, and the second instructions may be in a same query language. The query instructions may be composed in Structured Query Language (SQL). A grammar used to construct the syntactic database query may include an extension of Structured Query Language (SQL). The second entity may be an independent iteration over the first entity.

The first aggregate function may visually separate the first base from the first range. The first range may be surrounded by a set of delineating characters. The set of delineating characters may include at least one of parentheses and brackets.

In one aspect, the present disclosure describes a system that may include a parser configured to parse a syntactic database query. The syntactic database query may include two or more of tokens. A subset of the two or more of tokens may include a nested aggregation. The nested aggregation may include at least (a) a first aggregate expression including a first aggregate function, a first base, and a first range, and (b) a second aggregate expression including a second aggregate function, a second base and a second range, where the second range includes the first aggregate expression. Parsing the syntactic database query may include identifying at least a first token including a first name, and a second token including a second name. The system may further include a database system catalog including two or more entities and two or more associations, where each respective association may associate one or more entities of the two or more of entities. The system may further include a syntax binding engine configured to create one or more entity associations between one or more tokens and one or more entities in the system catalog. Creating the one or more entity associations may include creating a first entity association between the first name and a first entity in the system catalog, where the first aggregate expression includes the first name. Creating the one or more entity associations may further include determining a first association between the first entity and a second entity based in part upon both the second name and a association of the two or more of associations. Creating the one or more entity associations may further include creating a second entity association between the second name and the second entity, where the second aggregate expression includes the second name. The system may further include a grouping engine configured to associate one or more rows of the first entity onto one or more sets of rows of the second entity based in part upon the one or more entity associations. The system may further include a syntax builder configured to generate instructions. The syntax builder may generate first instructions for converting the one or more sets of rows of the second entity into a set of values using the second aggregate function, and generates second instructions for performing the first aggregate function using the set of values.

Parsing the syntactic database query may further include identifying, for each of the two or more of tokens, at least a first query context and a second query context, where the first query context includes the first name, and the second query context includes the second name.

In one aspect, the present disclosure describes a non-transitory computer-readable medium, where the computer readable medium stores instructions that, when executed by a processor, may cause the processor to receive a syntactic database query for retrieving information, where the syntactic database query includes a two or more of tokens, a subset of the two or more of tokens includes a nested aggregation, and the nested aggregation includes at least (a) a first aggregate expression including a first aggregate function, a first base, and a first range, and (b) a second aggregate expression including a second aggregate function, a second base and a second range. The instructions, when executed, may further cause the processor to parse the two or more of tokens, where parsing includes identifying at least a first query context and a second query context. The first query context may include a first token of the two or more of tokens including a first name. The second query context may include a second token of the two or more of tokens including a second name. The instructions, when executed, may further cause the processor to access a system catalog including two or more entities and two or more associations, each association of the two or more associations identifying a respective association between one or more entities of the two or more of entities. The instructions, when executed, may further cause the processor to bind the first query context to a first entity of the two or more of entities in the system catalog based in part upon the first name, where the first query context includes the first aggregate expression. The instructions, when executed, may further cause the processor to determine a first entity association between the first entity and a second entity based in part upon both the second name and a first association of the two or more of associations. The instructions, when executed, may further cause the processor to bind the second query context to the second entity, where the second query context includes the second aggregate expression. The instructions, when executed, may further cause the processor to associate one or more rows of the first entity onto one or more sets of rows of the second entity. The instructions, when executed, may further cause the processor to generate first instructions, where the first instructions include conversion instructions for converting the one or more sets of rows of the second entity into a set of values using the second aggregate function. The instructions, when executed, may further cause the processor to generate second instructions, where the second instructions include aggregation instructions for performing the first aggregate function using the set of values.

The second range may include the first aggregate expression. The two or more associations may include named links.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIGS. 1A through 1D illustrate example graphical representations of the interconnections of query tokens within a database query;

FIGS. 2A and 2B illustrate additional example graphical representations of the interconnections of query tokens within a database query;

FIG. 3 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

A database system, in some implementations, may refer to a software-based system or application for the storage and retrieval of data objects. In some examples, a database system may be conceptually organized using a relational model, as a document store model, as a graph-oriented model, or other organizational methodology. In some examples, a database system may contain one or more features or provisions for navigating links between data objects or for joining sets of data objects. In some implementations, a database system may provide a method for the retrieval of data objects and related objects.

In some implementations, database systems may include an official ontology or schema system that catalogs sets (e.g., classes) of data objects (e.g., “entities”) stored in the database.

In some implementations, the ontology may catalog one or more potential relationships between sets of data objects (e.g., “links”). In some implementations, a system catalog may be layered on top of a database system through convention or manual configuration to externally provide information regarding entities and links. A query engine of a database system, in some implementations, may provide a textual syntax or programming interface (e.g., application programming interface (API)) for retrieving information. In some implementations, one or more access features of a database system may be layered on top of the database system through post-processing. For example, textual syntax provided by a user may be converted to an internal (e.g., native) programming interface containing one or more features mapped to query language supplied by a user.

A query language or query programming interface, in some implementations, may provide constructs for accessing information within a database. In some implementations, a query language may provide a method to navigate data objects, such as navigating between a first set of data objects related to a first entity and a second set of data objects related to a second entity. Examples of database query languages may include: Structured Query Language (SQL) (e.g., an American National Standards Institute (ANSI) standard relational database query language) or an extension thereof; Language Integrated Query (LINQ™) by Microsoft Corporation of Redmond, Wash.; the Open Data Protocol (OData™) by Microsoft for querying and updating data using the hypertext Transfer Protocol (HTTP); XQuery and XPath by the XML Query working group of the World Wide Web Consortium (W3C®) for querying document-oriented databases; SQLAlchemy by Michael Bayer, an object-relational mapper for the Python programming language; MultiDimensional eXpressions (MDX) for online analytical processing (OLAP) databases; SPARQL Protocol and RDF Query Language (SPARQL) by the Resource Description Framework (RDF) Data Access Working Group (DAWG) of the World Wide Web Consortium, a language for (RDF) graph databases; Neo4j by Neo Technology, a graph database and query language; and Unstructured Query Language (UnQL), a public domain query language for not only SQL (NoSQL) databases.

Query syntax may be constructed of a number of individual tokens. A token, in some examples, may include a name referring to an entity (e.g., table, view, or other set of data with a similar structure) or a member of an entity (e.g., rows, values, portions of data belonging to an individual entity), or a name referring to a link between entities or to a particular entity. In other examples, a token may include a function or operator (e.g., average, count, list, group, etc.), or formatting syntax (e.g., parentheses, brackets, etc.). Functional elements, as used herein, may refer to one or more names, functions, and operators included in the query tokens.

In some implementations, the present disclosure may be directed to a method, architecture, and syntax for retrieving information from a database using a nested aggregate. A nested aggregate, for example, may refer to using the result of a first aggregation function (e.g., reduction of a set of data to a single data value) as an input expression to a second aggregation function. In some implementations, “base” may refer to a set of elements. The output of the aggregate function, for example, may be calculated for each element in the set of elements included in the “base”. The “range” or “span,” in some implementations, may refer to data correlating to elements in the base. The correlating data, for example, may be subject to aggregation (e.g., reduction of the set of data to a single data value). In some implementations, the base may be determined in part through the context of the query. The range, in some implementations, may be determined in part through the context within the aggregate function.

The syntax, in some implementations, may include a query expression in which the aggregate function visually separates the base and the range. In some implementations, an aggregate expression may include an aggregate function plus a set of delimiting characters used to bound the range of the aggregate expression. In a particular example, the query “school {count(department)}” may include a range of the functional element “department”, as delimited by parentheses following the aggregation function “count.” Further to the example, the functional element “school” may be the base of the aggregation function “count,” where the aggregation function “count” visually separates the base of “school” from the range of “department.”

In an example involving a nested aggregation function, the query “school{avg(department.count(course))}” may include a first aggregate function “count( )” nested within a second aggregate function “avg( )” In this example, the range of the first aggregate function may include the functional element “course,” while the base may include the functional element “department.” Upon resolving the first aggregate expression, the output of the aggregate function “count( )” (e.g., the number of courses by department) may be provided to the second aggregation function “avg( ).” The second aggregation function “avg( ),” in this example, may have a range of the number of courses by department, as determined by the first aggregate expression, while the second aggregate function “avg( )” may have a base of the functional element “school”. Hence, further to the example, a fully resolved nested aggregate expression may provide the average number of courses per department of each school returned as a query result.

In some implementations, an architecture for retrieving information from a database using a nested aggregate may include a catalog function used to build a system catalog which may model the database in terms of relationships. The system catalog, in some implementations, may be used for tracking the database entities (e.g., tables, views, documents, etc.) and database links (e.g., foreign key links, composite links, associations, relationships, references, etc.). The database links, in some implementations, may include named database links that are named relative to an entity such that they may be associated with functional elements of a query. The named database links, in some implementations, may include implementation-specific information regarding relationships between entities. In a particular example, a named database link may include one or more column associations used to join two tables of a relational database model. In some implementations, a single named database link may be treated as two links, for example as a first link from entity A to entity B, and as a second link from entity B to entity A.

The catalog function, in some implementations, may include a feature for tracking cardinality in relation to the named database links. For example, the cardinality tracking feature may involve differentiating one-to-one correlations in comparison to one-to-many correlations with reference to the named database links.

In some implementations, an architecture for retrieving information from a database using a nested aggregate expression may include a syntax tree building engine for modeling the syntax of the database query. In some implementations, a syntax tree representation of a query may include a logical model of the query syntax, for example tracked within the memory of a computer processor as associations between tokens of the query.

In some implementations, the syntax tree building engine may include a context-sensitive syntax binding engine. The context-sensitive syntax binding engine, in some implementations, may correlate relationships between entities as referenced in the system catalog to associations and operators derived from a context-sensitive analysis of the query syntax. In some implementations, the context-sensitive syntax binding engine may resolve links between a first entity and a second entity relative to information regarding the first entity. For example, a COURSE table may include a link to a DEPARTMENT table and a link to an INSTRUCTOR table. The link name “course”, in this example, may depend upon context. If, in a first instance, navigation originates from the DEPARTMENT context, the link name “course” may be inferred to correspond to an association between the DEPARTMENT table and the COURSE table. If, in a second instance, navigation originates from the INSTRUCTOR context, the link name “course” may be inferred to correspond to an association between the INSTRUCTOR table and the COURSE table. In other words, two links may share the link name “course” while referring to different navigation paths within the database.

In some implementations, the second entity is a second iteration over the first entity (e.g., a same entity). For example, one or more columns of a particular entity may be associated back to the same entity recursively. In another example, two members of a same class may reference each other. In some implementations, the context sensitive syntax binding engine may generate a bound syntax tree model including logical references established between relative query syntax and relationships as tracked by the system catalog.

In some implementations, the context sensitive syntax binding engine may verify that any operators used for performing an aggregation of a particular functional element are applied only to multiple-member functional elements. For example, a “count”, “sum”, or “average” function, according to the rules of the context-sensitive syntax binding engine, may only be allowed to be applied on functional elements (e.g., columns, entities, etc.) involving two or more members (e.g., rows, entries, etc.). In some implementations, an error may be flagged upon detection of a singular (e.g., one-to-one) navigation link in an aggregation expression.

In some implementations, an architecture for retrieving information from a database using a nested aggregate may include a framework grouping engine for associating members of one entity (e.g., the base) onto two or more members of another entity (e.g., the range). The framework grouping engine, in some implementations, may combine all expressions that are singular with respect to a particular navigation path. For example, the framework grouping engine may collapse multiple expressions that reference a same intermediate entity (e.g., table), or expressions on related entities that may be accessed using a singular link (e.g., a link from one member of a given entity relative to at most one other member of a given entity). In some implementations, functions performed within an inner framework of the framework grouping engine may supply information to functions performed within an outer framework of the framework grouping engine. For example, beginning with the second aggregate expression of a nested aggregation, the relationship between entities involved in the aggregation may be reduced to an inner framework containing one or more expressions including the second aggregate expression. Results obtained from resolving the one or more expressions within the inner framework, for example, may be supplied to an outer framework containing at least one expression (e.g., including the first aggregate expression). The inner framework may be related to the outer framework, in some implementations, based in part upon the logical references established between relative query syntax and relationships as tracked by the system catalog. For example, an inner framework may be logically connected to an outer frame work through a foreign key relationship or similar relational linking.

The framework grouping engine, in some implementations, may supply instructions for performing operations contained within each framework level. The instructions, in some examples, may include instructions formed in the same query language as the language used in the query provided, a translation to another query language, or an implementation of an internal database aggregation feature (e.g., using an internal or native programming interface). The instructions, in some implementations, may include SQL statements. The generation of instructions from an initial query, in some implementations, may provide a user with the ability to submit a concise and intuitive query expression for retrieving information that may associated with a complex collection of operations at the level of a query engine such as an SQL engine. In some implementations, the instructions may be used to perform a nested aggregation upon the underlying database without conflating a projection.

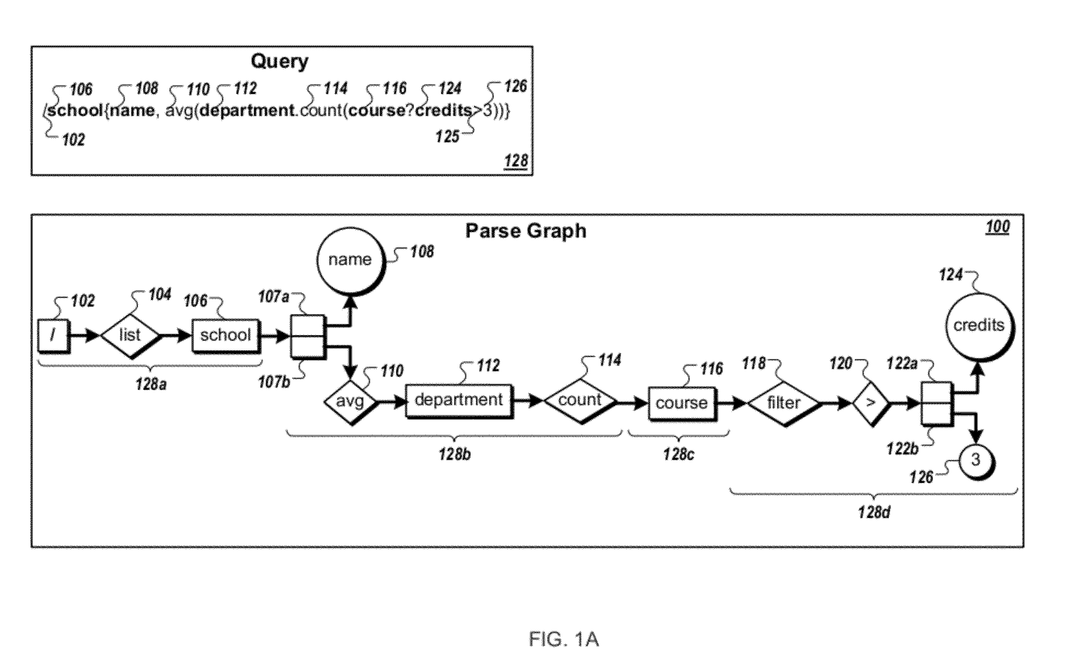

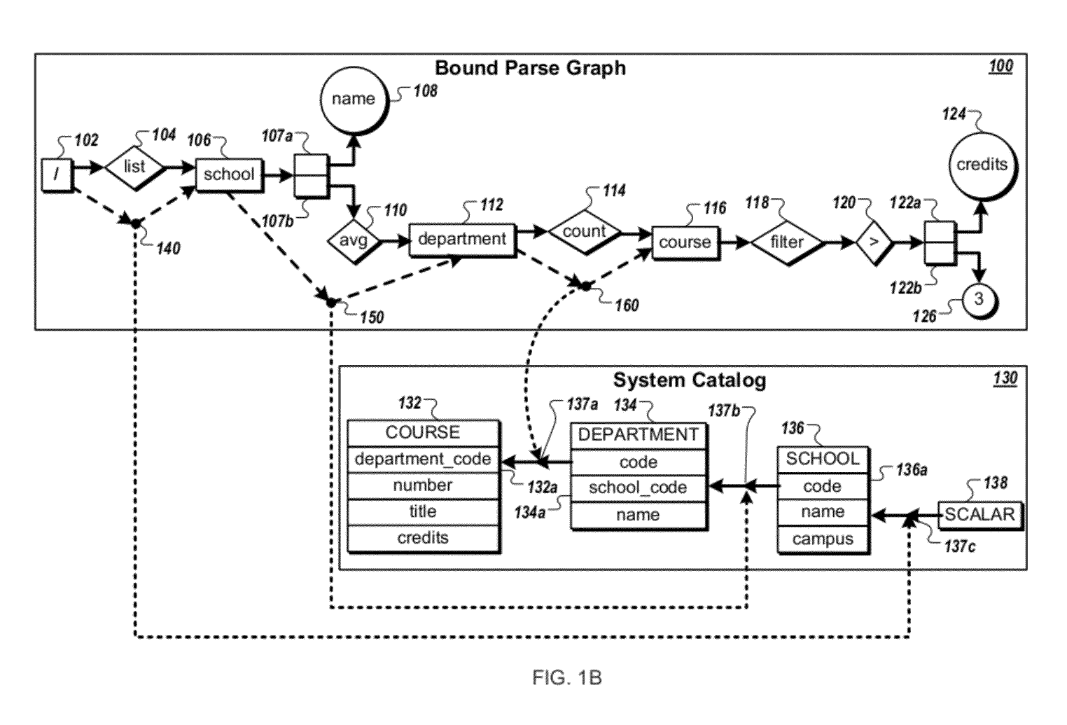

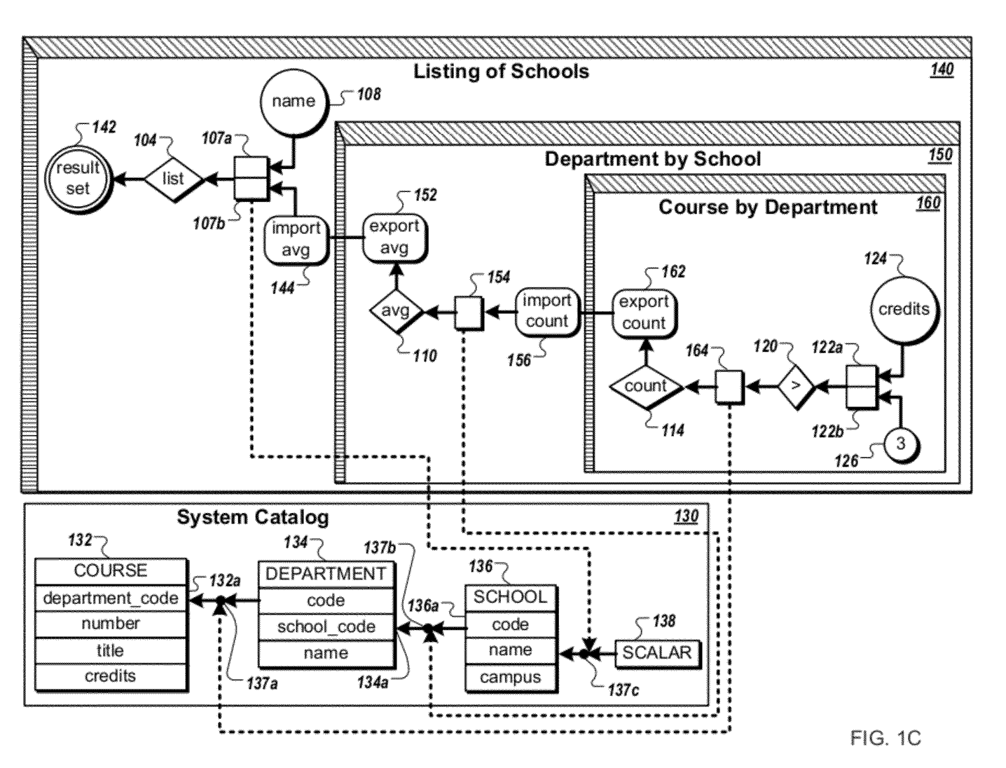

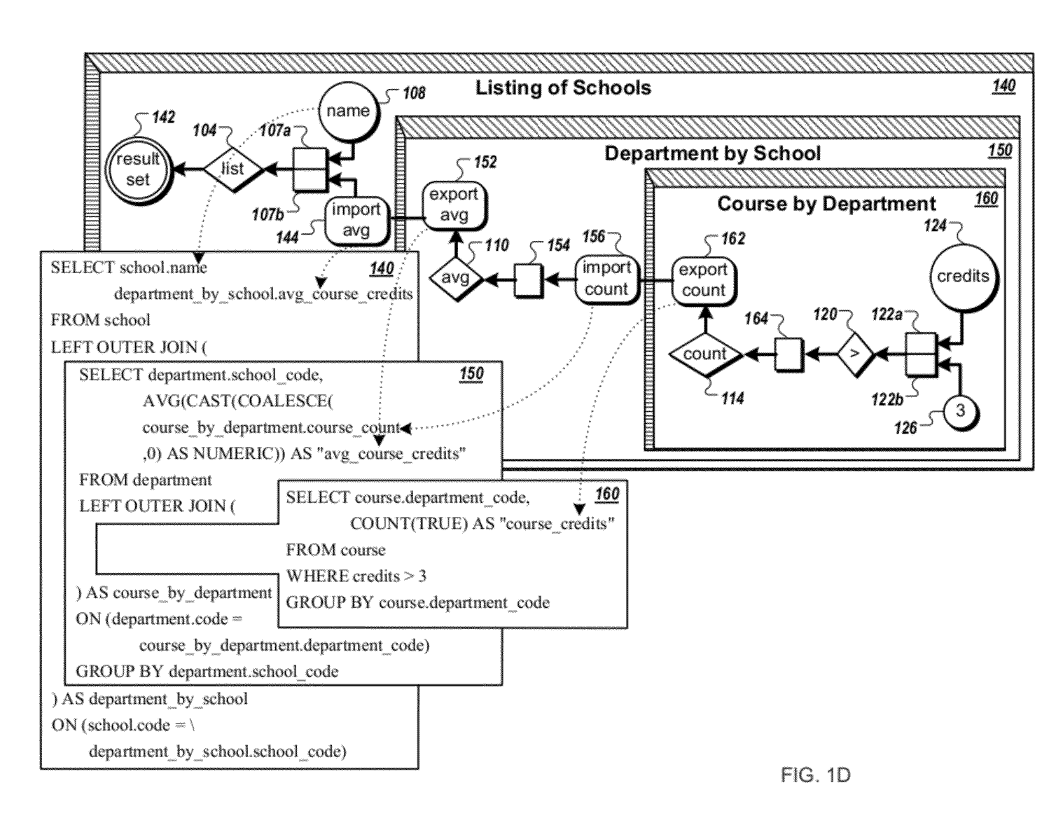

FIGS. 1A through 1D, in some implementations, illustrate example graphical models of the parsing and analysis of a query 128 including a nested aggregation. Turning to FIG. 1A, the example query 128 “/school{name, avg(department.count(course?credits>3))}” may include a root operator 102 (“/”), a first name 106 (“school”), a second name 108 (“name”), a third name 112 (“department”), a fourth name 116 (“course”) and a fifth name 126 (“credits”). The query 128 may further include a first aggregate function 110 (“avg”) and a second aggregate function 114 (“count”).

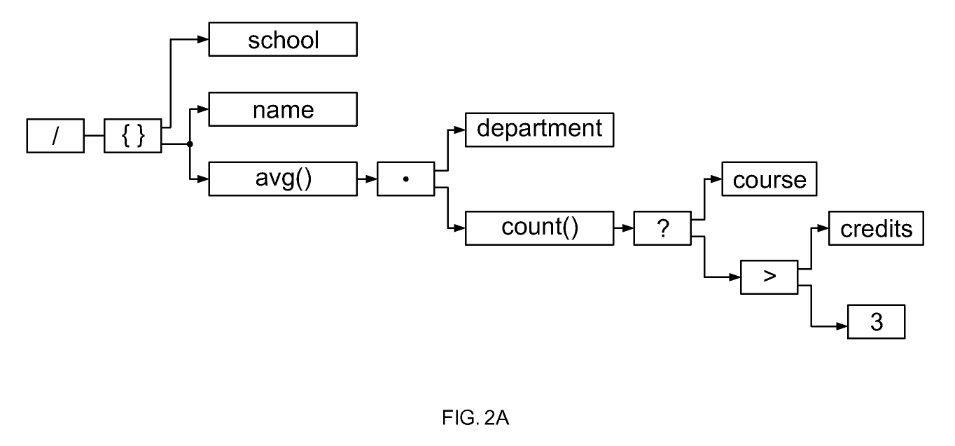

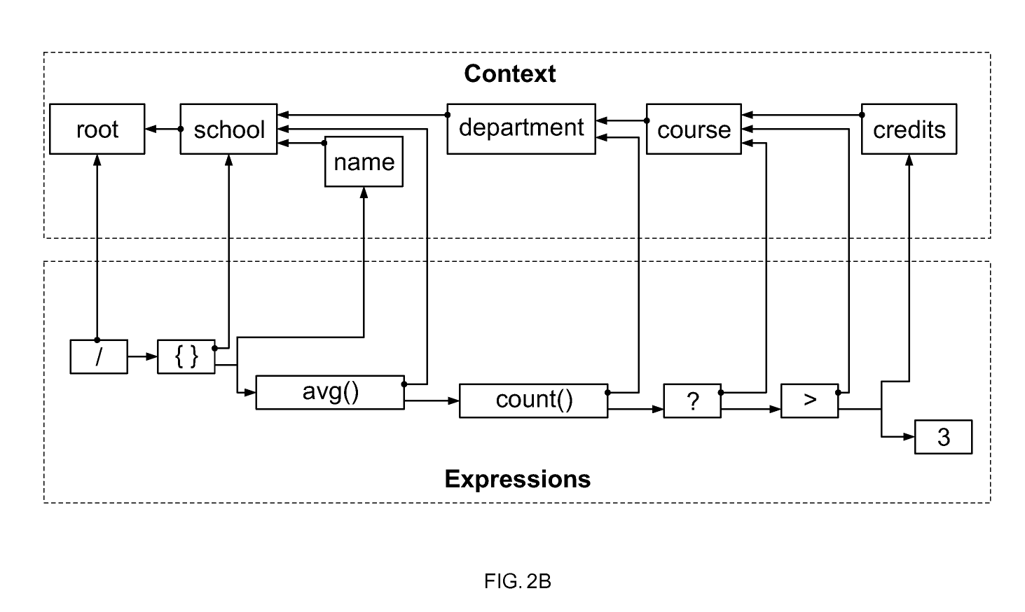

The query 128, in some implementations, may be provided to a syntax tree building engine to generate a parse graph 100. The parse graph 100, in some implementations, may illustrate a map of the query syntax as relationships between individual functional elements. Another example version of a parse graph of the query 128 is illustrated in FIG. 2A. As illustrated within the parse graph 100, the root operator 102 may provide a root context 128a to a list operation 104 (e.g., a root level implicit operation for listing results of a query). The root context 128a, in some implementations, may be used to infer a scope, associating tokens within the root context 128a, for example, with the root entity. The list operation, for example, may involve the first name 106 (“school”).

From the first name 106 (“school”), as illustrated in the query 128, the context of the query 128 may switch to a school context 128b. In some implementations, each token of the query 128 appearing within the scope of the school context 128b may be associated with a school entity. The school context 128b may include a selector 107 that branches to two separate values 107a, 107b. The first value 107a may include the second name 108 (“name”), illustrated as a scalar, or determined, value (e.g., in relation to the first name 106). The second selection 107b may include the resolution of the expression containing the first aggregate function 110 (“avg”).

Following the syntax tree branch of the first aggregate function 110 (“avg”), the school context 128b may include the third name 112 (“department”) and the second aggregate function 114 (“count”). As illustrated within the school context 128b, the second aggregate function 114 may be considered to be nested within the first aggregate expression containing the first aggregate function 110 (“avg”).

Upon encountering the fourth name 116 (“course”), as illustrated, the context of the query may switch from the school context 128b to a department context 128c. In some implementations, each token of the query 128 appearing within the scope of the department context 128c may be associated with a department entity. For example, the fourth name 116 (“course”) may be resolved in relation to the third name 112 (“department”). Continuing with the syntax tree branch involving the first aggregate function 110 (“avg”), a filter operation 110 may be included within a course context 128d. In some implementations, each token of the query 128 appearing within the scope of the course context 128d may be associated with a course entity. The filter operation 110, for example, may be used to filter the fourth name 116 (“course”) by a greater than operator 120 using a selector 122 involving the fifth name 124 (“credits”) and a scalar value 126 (“3”).

Based upon context changes, in some implementations, relationships between the names 106, 112, and 116 may be derived, for example using a system catalog 130, as illustrated in FIG. 1B. Turning to FIG. 1B, in some implementations, the structure of the parse graph 100 may be enhanced to include bindings as determined through the system catalog 130. Another example of binding system catalog information to a parse graph, in relation to the query 128, is illustrated in FIG. 2B. The system catalog 130, in some implementations, may include each of the entities within the database such as a course entity 132, a department entity 134, and a school entity 136. The system catalog 130, in some implementations, may additionally include a scalar entity 138. The scalar entity 138, for example, may be used as a root context to complete the resolution of query syntax within the database. A series of link operators 137 may illustrate relationships between the entities 132, 134, 136, and 138, for example based upon explicit relationships as established in the creation of the database, such as foreign key relationships. In some implementations, the system catalog 130 may include a cardinality of each of the link operators 137 (e.g., one-to-one, one-to-many, many-to-many).

Turning to the parse graph 100, a first binding of a first relationship between the root operator 102 and the first name 106 (“school”) may resolve to a link operator 137c between the school entity 136 and the scalar entity 138. For example, this may be illustrated by a grouping engine 140 (e.g., all schools within the root context of the database). Similarly, a second relationship between the first name 106 (“school”) and the second name 112 (“department”) may resolve to a link operator 137b between the school entity 136 and the department entity 134. For example, this may be illustrated by a grouping engine 150 grouping, for example, the concept of “departments by school”. In some implementations, the school entity 136 may have a one-to-many cardinality with the department entity 134 (e.g., multiple departments per school). Turning to a third relationship between the second name 112 (“department”) and the third name 116 (“course”), the third relationship may be resolved by a linking operator 137a between the department entity 134 and the course entity 132. For example, this may be illustrated by a grouping engine 160 associating, for example, the concept of “courses by department” based upon the course entity and the department entity. In some implementations, the department entity 134 may have a one-to-many cardinality with the course entity 132 (e.g., multiple courses per department).

Based upon the grouping engines 150 and 160 as derived by binding the parse graph 100 to the system catalog 130, in some implementations, the context and syntax of the query 128 may be further resolved into a frame graph format illustrating the interrelationships between the groups of information. Turning to FIG. 1C, in some implementations, the grouping engines 140, 150, and 160 may be illustrated in a “nested” format where, for example, the grouping 150 may be considered to be a subset of the grouping 140 and, furthermore, the grouping 160 may be considered to be a subset of the grouping 150. In some implementations, the relationships between each of the grouping engines 140, 150, and 160 may be determined in part by the linking operators 137 as determined by the binding of the query syntax of the query 128 with the system catalog 130.

As illustrated, each of the grouping engines 140, 150, and 160 may include an expression resolving a respective function 114, 110, 104. Each of the functions 114, 110, 104 may operate upon a set of values as determined through the linking operators 137. For example, based upon the linking operator 137a, a collection of courses 164 (e.g., instantiations of the course entity 132) may be counted by the aggregate function 114. A resultant count may be exported 162 to the grouping engine 150 (e.g., “department by school”) where the resultant count may be used as input to the average function 110 in view of the instantiations of the entity department 134 as determined via the linking operator 137b. The result of the average aggregate function 110 may be exported 152 to the root grouping engine 140 where the imported values 144 may contribute to the list function 104 to supply a result set 142.

Although each of the grouping engines 140, 150, and 160, as illustrated, involve only a single expression each, in some implementations, multiple expressions may be resolved within a particular grouping engine. For example, two or more expressions relative to a singular link may be included in a same grouping engine.

The expressions contained within each of the grouping engines 140, 150, and 160, in some implementations, may be individually reduced to instructions for accessing the underlying database. Beginning with the innermost grouping engine, 160, for example, instructions functionally equivalent to the expression contained within the grouping engine 160 may be used to provide a result that may in turn be provided as input to the expression(s) within the next level of grouping engine (e.g., the grouping engine 150). Similarly, the “output” of the instructions generated based upon the expression(s) within the grouping engine 150 may be supplied to the instructions generated from the expression(s) contained within the grouping engine 140.

Turning to FIG. 1D, instructions generated for each of the grouping engines 140, 150, 160, in some implementations, may be provided in a SQL grammar. Beginning with the innermost grouping engine 160, for example, the expression(s) contained within the grouping engine 160 may translate to the following query instructions (e.g., as represented in lines of SQL code):

SELECT course.department_code,
COUNT(TRUE) AS “course_credits”
FROM course
WHERE credits > 3
GROUP BY course.department_code

This query language, for example, may be referred to as the COURSE BY DEPARTMENT SUB-QUERY. Within the query instructions provided, “course_credits,” for example, may relate to the exporting 162 of information from the grouping engine 160. Note that the GROUP BY operator uses information from the link “department->course”. The output of the above query instructions with respect to the entity department, having at most one output row per department, may include a count of credit records.

Following this construct, the next level of grouping engine, the grouping engine 150, may translate, for example, to the following query instructions:

```
SELECT department.school_code,
      AVG(CAST(COALESCE(
          course_by_department.course_count ,0)
      AS NUMERIC)) AS “avg_course_credits”
FROM department
LEFT OUTER JOIN (
          [COURSE BY DEPARTMENT SUB-QUERY] )
AS course_by_department
ON (department.code =
      course_by_department.department_code)
GROUP BY department.school_code
```

where [COURSE BY DEPARTMENT SUB-QUERY] may be replaced with the query instructions provided above in relation to the innermost grouping engine 160. This segment of query instructions, for example, may be referred to as the DEPARTMENT BY SCHOOL SUB-QUERY. As provided in the example query instructions of the grouping engine 150, for example, the expression “avg_course_credits” may relate to the exporting 152 of information from the grouping engine 150. The expression “course_by_department.course_count”, for example, may be derived from information imported 156 from the grouping engine 160 (e.g., as resolved through the COURSE BY DEPARTMENT SUB-QUERY). As provided in the query instructions above, in addition to the “avg” function calculation, the expression(s) contained within the grouping engine 150 may include the school code link and may group by the school code, for example, for correlation to the grouping engine 140. The output of the DEPARTMENT BY SCHOOL SUB-QUERY, therefore, may provide at most one average for each member “school”. The “ON” clause, as provided in the example query instructions, may correlate the output of the grouping engine 150 to the calculation provided by the grouping engine 160 (e.g., the COURSE BY DEPARTMENT SUB-QUERY) by matching on the department code.

As provided in the DEPARTMENT BY SCHOOL SUB-QUERY, the COALESCE function, in some implementations, may be included within the query instructions to provide an accurate calculation of the average.

Turning to the outermost grouping engine 140, in some implementations, the expression(s) contained within the outermost grouping engine 140 may translate to, for example, to the following query instructions:

```
SELECT school.name
      department_by_school.avg_course_credits
FROM school
LEFT OUTER JOIN (
      [DEPARTMENT BY SCHOOL SUB QUERY] )
AS department_by_school
ON (school.code = department_by_school.school_code)
```

where [DEPARTMENT BY SCHOOL SUB-QUERY] may be replaced with the query instructions provided above in relation to the grouping engine 150 (e.g., including the COURSE BY DEPARTMENT SUB-QUERY provided above in relation to the grouping engine 160). As provided in the example query instructions of the grouping engine 140, the expression “department_by_school.avg_course_credits”, for example, may be derived from information imported 144 from the grouping engine 150 (e.g., as resolved through the DEPARTMENT BY SCHOOL SUB-QUERY).

Note within the query instructions correlating to the grouping engine 140 (e.g., the main set of query instructions, incorporating the nested instructions as translated from the grouping engine 150 and the grouping engine 160), the DEPARTMENT BY SCHOOL SUB-QUERY, having singular correspondence to school (e.g., each department correlates to a single school), may be correlated to the school by the school code.

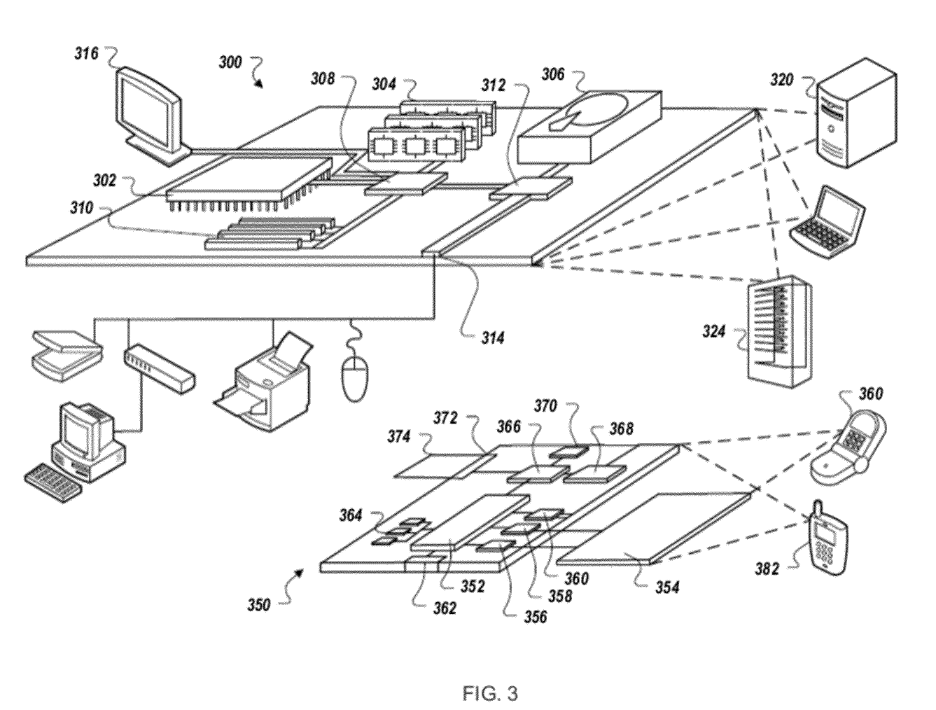

FIG. 3 shows an example of a computing device 300 and a mobile computing device 350 that can be used to implement the techniques described in this disclosure. The computing device 300 is intended to represent various forms of digital computers, such as laptops, desktops, workstations, personal digital assistants, servers, blade servers, mainframes, and other appropriate computers. The mobile computing device 350 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 300 includes a processor 302, a memory 304, a storage device 306, a high-speed interface 308 connecting to the memory 304 and multiple high-speed expansion ports 310, and a low-speed interface 312 connecting to a low-speed expansion port 314 and the storage device 306. Each of the processor 302, the memory 304, the storage device 306, the high-speed interface 308, the high-speed expansion ports 310, and the low-speed interface 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as a display 316 coupled to the high-speed interface 308. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 304 stores information within the computing device 300. In some implementations, the memory 304 is a volatile memory unit or units. In some implementations, the memory 304 is a non-volatile memory unit or units. The memory 304 may also be another form of computer-readable medium, such as a magnetic or optical disk.

The storage device 306 is capable of providing mass storage for the computing device 300. In some implementations, the storage device 306 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 302), perform one or more methods, such as those described above. The instructions can also be stored by one or more storage devices such as computer- or machine-readable mediums (for example, the memory 304, the storage device 306, or memory on the processor 302).

The high-speed interface 308 manages bandwidth-intensive operations for the computing device 300, while the low-speed interface 312 manages lower bandwidth-intensive operations. Such allocation of functions is an example only. In some implementations, the high-speed interface 308 is coupled to the memory 304, the display 316 (e.g., through a graphics processor or accelerator), and to the high-speed expansion ports 310, which may accept various expansion cards (not shown). In the implementation, the low-speed interface 312 is coupled to the storage device 306 and the low-speed expansion port 314. The low-speed expansion port 314, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. In addition, it may be implemented in a personal computer such as a laptop computer 322. It may also be implemented as part of a rack server system 324. Alternatively, components from the computing device 300 may be combined with other components in a mobile device (not shown), such as a mobile computing device 350. Each of such devices may contain one or more of the computing device 300 and the mobile computing device 350, and an entire system may be made up of multiple computing devices communicating with each other.

The mobile computing device 350 includes a processor 352, a memory 364, an input/output device such as a display 354, a communication interface 366, and a transceiver 368, among other components. The mobile computing device 350 may also be provided with a storage device, such as a micro-drive or other device, to provide additional storage. Each of the processor 352, the memory 364, the display 354, the communication interface 366, and the transceiver 368, are interconnected using various buses, and several of the components may be mounted on a common motherboard or in other manners as appropriate.

The processor 352 can execute instructions within the mobile computing device 350, including instructions stored in the memory 364. The processor 352 may be implemented as a chipset of chips that include separate and multiple analog and digital processors. The processor 352 may provide, for example, for coordination of the other components of the mobile computing device 350, such as control of user interfaces, applications run by the mobile computing device 350, and wireless communication by the mobile computing device 350.

The processor 352 may communicate with a user through a control interface 358 and a display interface 356 coupled to the display 354. The display 354 may be, for example, a TFT (Thin-Film-Transistor Liquid Crystal Display) display or an OLED (Organic Light Emitting Diode) display, or other appropriate display technology. The display interface 356 may include appropriate circuitry for driving the display 354 to present graphical and other information to a user. The control interface 358 may receive commands from a user and convert them for submission to the processor 352. In addition, an external interface 362 may provide communication with the processor 352, so as to enable near area communication of the mobile computing device 350 with other devices. The external interface 362 may provide, for example, for wired communication in some implementations, or for wireless communication in other implementations, and multiple interfaces may also be used.

The memory 364 stores information within the mobile computing device 350. The memory 364 can be implemented as one or more of a computer-readable medium or media, a volatile memory unit or units, or a non-volatile memory unit or units. An expansion memory 374 may also be provided and connected to the mobile computing device 350 through an expansion interface 372, which may include, for example, a SIMM (Single In Line Memory Module) card interface. The expansion memory 374 may provide extra storage space for the mobile computing device 350, or may also store applications or other information for the mobile computing device 350. Specifically, the expansion memory 374 may include instructions to carry out or supplement the processes described above, and may include secure information also. Thus, for example, the expansion memory 374 may be provide as a security module for the mobile computing device 350, and may be programmed with instructions that permit secure use of the mobile computing device 350. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. The instructions, when executed by one or more processing devices (for example, processor 352), perform one or more methods, such as those described above. The instructions can also be stored by one or more storage devices, such as one or more computer- or machine-readable mediums (for example, the memory 364, the expansion memory 374, or memory on the processor 352). In some implementations, the instructions can be received in a propagated signal, for example, over the transceiver 368 or the external interface 362.

The mobile computing device 350 may communicate wirelessly through the communication interface 366, which may include digital signal processing circuitry where necessary. The communication interface 366 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 368 using a radio-frequency. In addition, short-range communication may occur, such as using a Bluetooth®, Wi-Fi™, or other such transceiver (not shown). In addition, a GPS (Global Positioning System) receiver module 370 may provide additional navigation- and location-related wireless data to the mobile computing device 350, which may be used as appropriate by applications running on the mobile computing device 350.

The mobile computing device 350 may also communicate audibly using an audio codec 360, which may receive spoken information from a user and convert it to usable digital information. The audio codec 360 may likewise generate audible sound for a user, such as through a speaker, e.g., in a handset of the mobile computing device 350. Such sound may include sound from voice telephone calls, may include recorded sound (e.g., voice messages, music files, etc.) and may also include sound generated by applications operating on the mobile computing device 350.

The mobile computing device 350 may be implemented in a number of different forms, as shown in the figure. For example, it may be implemented as a cellular telephone 380. It may also be implemented as part of a smart-phone 382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, environments, methods and syntax for retrieving information from a database using a nested aggregate are provided. Having described certain implementations of methods and apparatus for supporting the retrieval of information from a database using a nested aggregate, it will now become apparent to one of skill in the art that other implementations incorporating the concepts of the disclosure may be used. Therefore, the disclosure should not be limited to certain implementations, but rather should be limited only by the spirit and scope of the following claims.

What is claimed:

1. A method comprising:
receiving a syntactic database query for retrieving information, wherein
the syntactic database query comprises a plurality of tokens,
a subset of the plurality of tokens comprises a nested aggregation, and
the nested aggregation comprises at least (a) a first aggregate expression comprising a first aggregate function, a first base, and a first range, and (b) a second aggregate expression comprising a second aggregate function, a second base and a second range, wherein the second range comprises the first aggregate expression;
parsing the plurality of tokens, wherein parsing comprises identifying at least a first query context and a second query context, wherein
the first query context comprises a first token of the plurality of tokens, wherein the first token comprises a first name, and
the second query context comprises a second token of the plurality of tokens, wherein the second token comprises a second name;
accessing a system catalog comprising a plurality of entities and a plurality of named links, each named link of the plurality of named links identifying an association between at least one entity of the plurality of entities;
binding the first query context to a first entity of the plurality of entities in the system catalog based in part upon the first name, wherein the first query context comprises the first aggregate expression;
determining a first association between the first entity and a second entity based in part upon both the second name and a first named link associated with the first entity in the system catalog;
binding the second query context to the second entity, wherein the second query context comprises the second aggregate expression;
associating one or more rows of the first entity onto one or more sets of rows of the second entity;
generating first instructions, wherein the first instructions comprise conversion instructions for converting the one or more sets of rows of the second entity into a set of values using the second aggregate function; and
generating second instructions, wherein the second instructions comprise aggregation instructions for performing the first aggregate function using the set of values.

2. The method of claim 1, wherein the database comprises a relational database.

3. The method of claim 1, wherein the system catalog further comprises a respective cardinality associated with each of the named links.

4. The method of claim 3, wherein the respective cardinality comprises one of (a) a one-to-one correlation, (b) a one-to-many correlation, and (c) a many-to many correlation.

5. The method of claim 3, wherein the method further comprises, prior to determining the association, verifying a first cardinality associated with the first named link is not a one-to-one cardinality.

6. The method of claim 1, wherein:
the plurality of entities comprises a scalar entity, and
the first query context is associated with the scalar entity.

7. The method of claim 1, wherein the first instructions and the second instructions are generated as native programming interface instructions.

8. The method of claim 1, wherein the first instructions and the second instructions are generated as query instructions.

9. The method of claim 8, wherein the syntactic database query, the first instructions, and the second instructions are in a same query language.

10. The method of claim 8, wherein the query instructions are composed in Structured Query Language (SQL).

11. The method of claim 1, wherein a grammar used to construct the syntactic database query comprises an extension of Structured Query Language (SQL).

12. The method of claim 1, wherein the second entity is an independent iteration over the first entity.

13. The method of claim 1, wherein the first aggregate function visually separates the first base from the first range.

14. The method of claim 13, wherein the first range is surrounded by a set of delineating characters.

15. The method of claim 14, wherein the set of delineating characters comprises at least one of parentheses and brackets.

16. A system comprising:
a parser configured to parse a syntactic database query, wherein
the syntactic database query comprises a plurality of tokens,
a subset of the plurality of tokens comprises a nested aggregation,
the nested aggregation comprises at least (a) a first aggregate expression comprising a first aggregate function, a first base, and a first range, and (b) a second aggregate expression comprising a second aggregate function, a second base and a second range, wherein the second range comprises the first aggregate expression,
parsing the syntactic database query comprises identifying at least
a first token comprising a first name, and
a second token comprising a second name;
a database system catalog comprising a plurality of entities and a plurality of associations, wherein each respective association associates one or more entities of the plurality of entities;
a syntax binding engine configured to create one or more entity associations between one or more tokens and one or more entities in the system catalog, wherein creating the one or more entity associations comprises
creating a first entity association between the first name and a first entity in the system catalog, wherein the first aggregate expression comprises the first name;
determining a first association between the first entity and a second entity based in part upon both the second name and a association of the plurality of associations; and
creating a second entity association between the second name and the second entity, wherein the second aggregate expression comprises the second name; and
a grouping engine configured to associate one or more rows of the first entity onto one or more sets of rows of the second entity based in part upon the one or more entity associations; and
a syntax builder configured to generate instructions, wherein the syntax builder
generates first instructions for converting the one or more sets of rows of the second entity into a set of values using the second aggregate function, and
generates second instructions for performing the first aggregate function using the set of values.

17. The system of claim 16, wherein parsing the syntactic database query further comprises identifying, for each of the plurality of tokens, at least a first query context and a second query context, wherein
the first query context comprises the first name, and
the second query context comprises the second name.

18. A non-transitory computer-readable medium, wherein the computer readable medium stores instructions that, when executed by a processor, cause the processor to:
receive a syntactic database query for retrieving information, wherein
the syntactic database query comprises a plurality of tokens,
a subset of the plurality of tokens comprises a nested aggregation, and
the nested aggregation comprises at least (a) a first aggregate expression comprising a first aggregate function, a first base, and a first range, and (b) a second aggregate expression comprising a second aggregate function, a second base and a second range;
parse the plurality of tokens, wherein parsing comprises identifying at least a first query context and a second query context, wherein
the first query context comprises a first token of the plurality of tokens comprising a first name, and
the second query context comprises a second token of the plurality of tokens comprising a second name;
access a system catalog comprising a plurality of entities and a plurality of associations, each association of the plurality of associations identifying a respective association between one or more entities of the plurality of entities;
bind the first query context to a first entity of the plurality of entities in the system catalog based in part upon the first name, wherein the first query context comprises the first aggregate expression;
determine a first entity association between the first entity and a second entity based in part upon both the second name and a first association of the plurality of associations;
bind the second query context to the second entity, wherein the second query context comprises the second aggregate expression;
associate one or more rows of the first entity onto one or more sets of rows of the second entity;
generate first instructions, wherein the first instructions comprise conversion instructions for converting the one or more sets of rows of the second entity into a set of values using the second aggregate function; and
generate second instructions, wherein the second instructions comprise aggregation instructions for performing the first aggregate function using the set of values.

19. The computer-readable medium of claim 18, wherein the second range comprises the first aggregate expression.

20. The system of claim 18, wherein the plurality of associations comprise named links.
